(19) United States
(12) Patent Application Publication
(10) Pub. No.: US 2015/0078241 A1
(43) Pub. Date: Mar. 19, 2015

(54) METHOD AND APPARATUS FOR SUPPORTING MULTICAST DELIVERY

(71) Applicant: Nokia Solutions and Networks Oy, Espoo (FI)

(72) Inventors: Xiang XU, Nanjing (CN); Henri Markus KOSKINEN, Espoo (FI); Curt WONG, Sammamish, WA (US)

(73) Assignee: Nokia Solutions and Networks Oy, Espoo (FI)

(21) Appl. No.: 14/026,659

(22) Filed: Sep. 13, 2013

(51) Int. Cl. H04L 12/18

(52) U.S. Cl. CPC H04L 12/189
USPC 370/312

(57) ABSTRACT

A method and apparatus can be configured to determine an indicator based on a received request. The method can also include transmitting the indicator towards a base station. The indicator affects the coverage of a multicast-broadcast single-frequency network transmission.

### BACKGROUND

1. Field

Embodiments of the invention relate to supporting multicast delivery in group communication.

2. Description of the Related Art

Long-term Evolution (LTE) is a standard for wireless communication that seeks to provide improved speed and capacity for wireless communications by using new modulation/signal processing techniques. The standard was proposed by the 3^{rd} Generation Partnership Project (3GPP), and is based upon previous network technologies. Since its inception, LTE has seen extensive deployment in a wide variety of contexts involving the communication of data.

### SUMMARY

According to a first embodiment, a method can include determining, by a broadcast/multicast service center, an indicator based on a received request. The method can also include transmitting the indicator towards a base station. The indicator affects the coverage of a multicast-broadcast single-frequency network transmission.

In the method of the first embodiment, the determining comprises determining the indicator based on a configuration of cells that are using multimedia-broadcast-multicast service.

In the method of the first embodiment, the transmitting comprises transmitting the indicator towards the base station via in-band signalling.

In the method of the first embodiment, the in-band signalling is performed using a certain synchronization protocol-data-unit type.

In the method of the first embodiment, the transmitting comprises transmitting the indicator towards the base station via session control signalling.

In the method of the first embodiment, the indicator identifies at least one of cells to be included for multicast-broadcast single-frequency network transmission, cells to be excluded from multicast-broadcast single-frequency network transmission, and a stop to service area restriction/override.

In the method of the first embodiment, the transmitting is optimized to only transmit the indicator to affected base stations.

According to a second embodiment, an apparatus includes at least one processor. The apparatus also includes at least one memory including computer program code. The at least one memory and the computer program code can be configured, with the at least one processor, to cause the apparatus at least to determine an indicator based on a received request. The apparatus can also be caused to transmit the indicator towards a base station. The indicator affects the coverage of a multi-broadcast single-frequency network transmission.

In the apparatus of the second embodiment, the determining comprises determining the indicator based on a configuration of cells that are using multimedia-broadcast-multicast service.

In the apparatus of the second embodiment, the transmitting comprises transmitting the indicator towards the base station via in-band signalling.

In the apparatus of the second embodiment, the in-band signalling is performed using a certain synchronization protocol-data-unit type.

In the apparatus of the second embodiment, the transmitting comprises transmitting the indicator towards the base station via session control signalling.

In the apparatus of the second embodiment, the indicator identifies at least one of cells to be included for multicast-broadcast single-frequency network transmission, cells to be excluded from multicast-broadcast single-frequency network transmission, and a stop to service area restriction/override.

In the apparatus of the second embodiment, the transmitting is optimized to only transmit the indicator to affected base stations.

According to a third embodiment, a computer program product is embodied on a non-transitory computer readable medium. The computer program product can be configured to control a processor to perform a process. The process can include determining an indicator based on a received request. The process can also include transmitting the indicator towards a base station. The indicator affects the coverage of a multicast-broadcast single-frequency network transmission.

According to a fourth embodiment, a method can include receiving, by a base station, an indicator. The method can also include determining, based on the indicator, whether to contribute to a multicast-broadcast single-frequency network transmission. The indicator indicates at least one of cells to be included for the multicast-broadcast single-frequency network transmission, cells to be excluded from the multicast-broadcast single-frequency network transmission, and a stop to service area restriction/override.

In the method of the fourth embodiment, the receiving comprises receiving the indicator from a broadcast/multicast service center via in-band signalling.

In the method of the fourth embodiment, the in-band signalling is performed using a certain synchronization protocol-data-unit type.

In the method of the fourth embodiment, the receiving comprises receiving the indicator from a broadcast/multicast service center via session control signalling.

According to a fifth embodiment, an apparatus can include at least one processor. The apparatus can also include at least one memory including computer program code. The at least one memory and the computer program code can be configured, with the at least one processor, to cause the apparatus at least to receive an indicator. The apparatus can be caused to determine, based on the indicator, whether to contribute to a multicast-broadcast single-frequency network transmission. The indicator indicates at least one of cells to be included for the multicast-broadcast single-frequency network transmission, cells to be excluded from the multicast-broadcast single-frequency network transmission, and a stop to service area restriction/override.

In the apparatus of the fifth embodiment, the receiving comprises receiving the indicator from a broadcast/multicast service center via in-band signalling.

In the apparatus of the fifth embodiment, the in-band signalling is performed using a certain synchronization protocol-data-unit type.

In the apparatus of the fifth embodiment, the receiving comprises receiving the indicator from a broadcast/multicast service center via session control signalling.

According to a sixth embodiment, a computer program product can be embodied on a non-transitory computer readable medium. The computer program product can be configured to control a processor to perform a process comprising receiving an indicator. The process can also include determining, based on the indicator, whether to contribute to a multicast-broadcast single-frequency network transmission. The indicator indicates at least one of cells to be included for the multicast-broadcast single-frequency network transmission, cells to be excluded from the multicast-broadcast single-frequency network transmission, and a stop to service area restriction/override.

### BRIEF DESCRIPTION OF THE DRAWINGS

For proper understanding of the invention, reference should be made to the accompanying drawings, wherein:

FIG. 1 illustrates geographic scopes of group-communication-system-enabler (GCSE) groups.

FIG. 2 illustrates an architecture for 3GPP GCSE service.

FIG. 3 illustrates enhancing synchronization (SYNC) in accordance with embodiments of the present invention.

FIG. 4 illustrates an enhanced SYNC-PDU-T e-X data frame for starting GCSE area restriction/override in accordance with embodiments of the present invention.

FIG. 5 illustrates an enhanced SYNC-PDU-T e-X data frame for stopping GCSE area restriction/override in accordance with embodiments of the present invention.

FIG. 6 illustrates enhancing session control in accordance with embodiments of the present invention.

FIG. 7 illustrates a flowchart of a method in accordance with embodiments of the invention.

FIG. 8 illustrates a flowchart of a method in accordance with embodiments of the invention.

FIG. 9 illustrates an apparatus in accordance with embodiments of the invention.

FIG. 10 illustrates an apparatus in accordance with embodiments of the invention.

FIG. 11 illustrates an apparatus in accordance with embodiments of the invention.

### DETAILED DESCRIPTION

Embodiments of the present invention are related to multicast transmission for group-communication-system enablers (GCSE). GCSE can provide key functionality for public safety systems. GCSE can be standardized in accordance with 3GPP Release 12.

3GPP System-Aspects-Working-Group 1 (SA1) defines certain requirements regarding the geographic scope of a GCSE group, such as the requirement that a coverage area of the GCSE group may be changed during operation.

According to 3GPP SA1, GCSE groups shall, by definition, be of system-wide scope. Optionally, GCSE groups may be geographically restricted. The system shall provide a mechanism to restrict all group communications for a given GCSE group to a defined geographic area. In this case, group members of the given GCSE group shall be able to receive and/or transmit only within this geographic area. The system shall provide a mechanism to redefine the geographic area for the GCSE group that has a defined geographic area. The system shall provide a mechanism to override geographic area restrictions for a GCSE group for a particular group-communication transmission. The system shall provide a mechanism to restrict a particular group-communication transmission to a defined geographic area within the geographical scope of that group. In this case, only receiver group members within the geographic area shall receive the group communication.

In view of the above requirements as defined by 3GPP SA1, GCSE can dynamically adjust the coverage area of a GCSE group in certain circumstances. For example, the New York City Police Department (NYPD) can have a GCSE group with a coverage area that covers Central Park. In the event that an emergency event occurs in Central Park, the NYPD may want to deliver some desired data/information to only the police officers in and around Central Park. Therefore, by using the GCSE group with the coverage area that covers Central Park, the NYPD can deliver the desired data/information to only the officers in and around Central Park.

With respect to delivering the desired data/information, 3GPP System-Aspects-Working-Group 2 (SA2) defines two types of data/information delivery for GCSE service. One type of data/information delivery is multicast delivery. Multicast-delivery is a delivery mode where the group communication data is delivered via shared network resources to multiple group members. Another type of data/information delivery is unicast delivery. Unicast delivery is a delivery mode where the group communication data is delivered to a particular group member via resources dedicated to a group member.

Multicast delivery is generally more efficient than unicast delivery with respect to the use of radio resources. Multimedia-broadcast-multimedia service (MBMS) is generally used for GCSE multicast delivery, and a GCSE application server (AS) generally determines whether to use multicast delivery or to use unicast delivery.

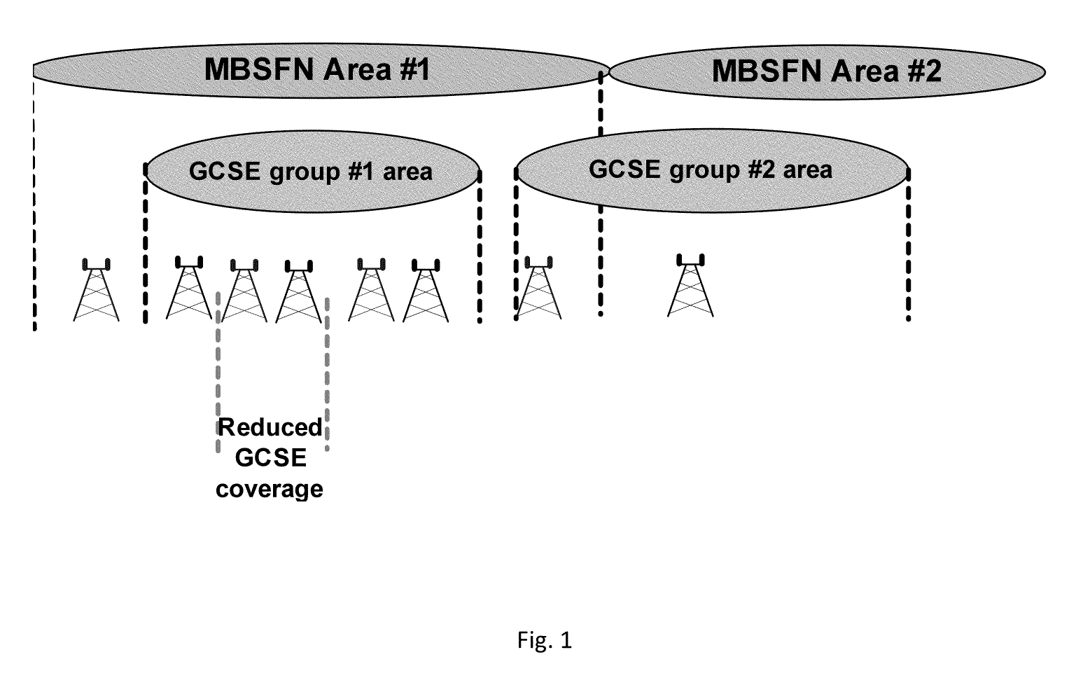

FIG. 1 illustrates geographic scopes of GCSE groups. Current multimedia-broadcast-multicast-service (MBMS) can be implemented via multicast-broadcast single-frequency network (MBSFN) transmissions. The coverage area of a MBSFN (such as MBSFN Area #1 and MBSFN Area #2) can be defined and semi-statically configured by a cellular operator. The coverage area for each GCSE group (such as GCSE group #1 and GCSE group #2), on the other hand, is defined by a GCSE service provider. Therefore, the coverage area of a MBSFN may not align with the coverage area for a specific GCSE group. In other words, the coverage area of a specific GCSE group may contain some, but not all, cells of a MBSFN area. For example, GCSE group #1 area contains some, but not all, cells of MBSFN Area #1. Further, even if the GCSE service provider coordinates with the cellular operator to define the coverage area of the GCSE group to be aligned with the MBMS service area, it still cannot support the above-mentioned dynamic restricting or overriding of geographic area restrictions for a GCSE group for a particular group-communication transmission. The main reason being that the MBMS service area and MBSFN area are statically defined.

Currently, when performing transmissions within a MBSFN, all base stations/evolved Node Bs (eNBs) of the MBSFN's coverage area (except for base stations/eNBs of a reserved cell) transmit the same content at the same time. In the event that a GCSE application server (AS) determines that multicast delivery should be used to deliver data/information for a GCSE group, current MBMS generally cannot allow the GCSE AS to distribute the data/information to just a select/limited number of cells (corresponding to the GCSE group) of a MBSFN area. Rather, current MBMS would generally require the data/information to be distributed to all of the cells of the MBSFN area.

According to the previous approaches that attempted to distribute data to a select/limited number of cells, one previous approach defines a separate MBSFN area for each GCSE group. In the event that the coverage area of a GCSE group needs to be enlarged or reduced, the GCSE AS switches from multicast delivery to unicast delivery. However, this switching can be very inefficient regarding the use of radio resources, as multicast delivery is generally more efficient than unicast delivery, as described above. In the event that an emergency event occurs, a large number of user equipment (UE) will generally be in the relevant area. However, the radio resources are usually scarce in the related cells, and the radio resources may not be able to support unicast delivery to all the UEs in the relevant area. So, the above-described previous approaches can be very inefficient and may not support unicast delivery to all related UEs.

In view of the difficulties of the previous approaches, embodiments of the present invention are directed to delivering data/information to a select/limited number of cells of a MBSFN coverage area, without the inefficiencies of the previous approaches. Embodiments of the present invention enable the delivery of data/information to a select/limited number of cells by conveying an indicator of whether a base station/eNB is supposed to participate in a group communication session. The indicator can be sent from a broadcast/multicast service center (BM-SC) to the base station/eNB.

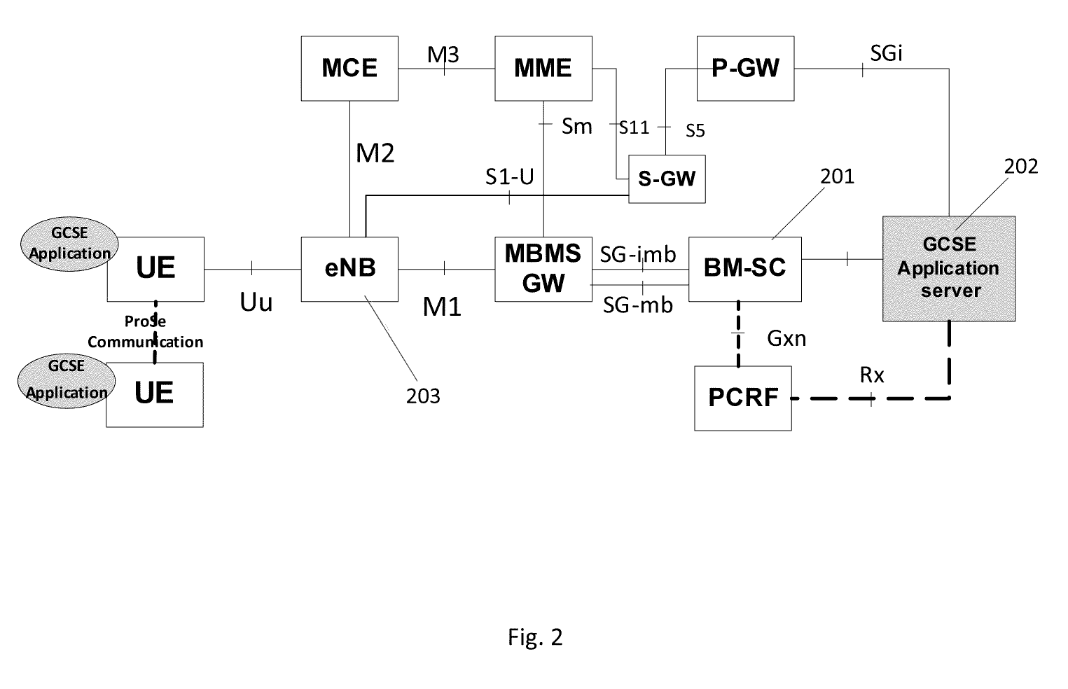

FIG. 2 illustrates an architecture for 3GPP GCSE service. In embodiments of the present invention, BM-SC 201 can determine an indicator (of whether a base station/eNB is supposed to participate in group communication) based on a request received from a GCSE AS 202 and based on the particular configuration of cells that are using the MBMS service. Specifically, BM-SC 201 can determine the indicator based on a GCSE area request from a GCSE AS 202 and the configuration.

BM-SC 201 may send the indicator to an eNB 203 via in-band signalling along with a data packet. The inband signalling can be performed using a SYNC protocol-data unit (PDU) Type X data frame. BM-SC 201 may also send the indicator to eNB 203 via session control signalling. The session control signalling can be an enhancement to current MBMS session control signalling, or the session control signalling can be a new session control signalling for group communication. Session control signalling may be distributed to all eNBs of an MBMS service area, or the session control signalling may only distribute the control signalling to relevant eNBs. The indicator can indicate at least one of (1) information of cells to be included for group communication, (2) information of cells to be excluded from group communication, and (3) a stopping of service-area filtering and/or restriction/override. The information of the cells could be cell IDs or eNB IDs, or a list of TAI (Tracking Area Identities), or area names, or location codes, or any other information that can identify the affected cells.

Embodiments of the present invention can also be directed to receiving, by a base station/eNB, an indicator that decides whether the base station/eNB is to contribute to a group communication using current MBSFN transmission. A cell to be excluded from the group communication can continue delivering multicast-control channel (MCCH) transmissions, while muting delivery of multicast-traffic-channel (MTCH) transmissions.

In view of the above, embodiments of the present invention can provide certain advantages. For example, certain embodiments of the present invention can be more resource-efficient when using MBSFN transmissions, as compared to the previous approaches. Certain embodiments of the present invention can provide better performance when transmitting MBSFN transmissions. Certain embodiments of the present invention can minimize changes to existing systems. For example, certain embodiments can be implemented without implementing changes to a MCE/MME/MBMS-gateway.

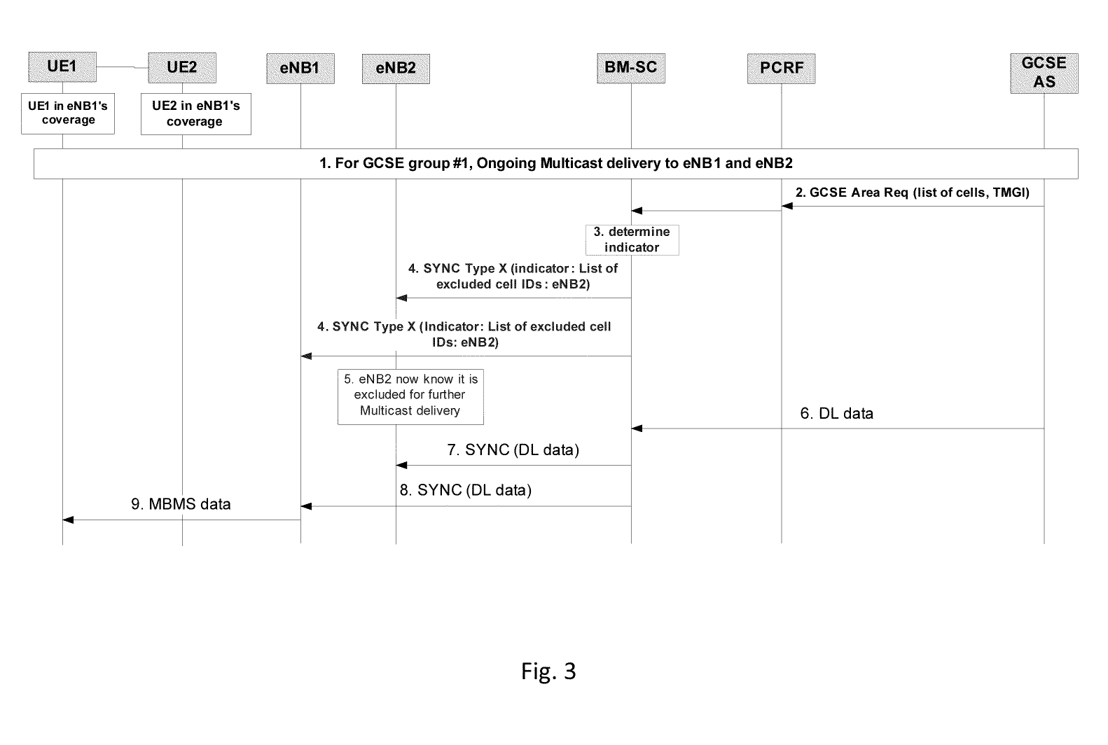

FIG. 3 illustrates enhancing synchronization (SYNC) in accordance with embodiments of the present invention. Referring to FIG. 3, in certain embodiments, the coverage area of a GCSE group #1 can contain two eNBs (i.e., eNB1 and eNB2). Referring to step 1, GCSE AS can use multicast delivery. In the event of an emergency event in eNB 1's coverage area, the GCSE group administrator would like to limit the GCSE transmission to only cells in eNB 1's coverage area. In step 2, the GCSE AS sends a GCSE area request that informs the BM-SC that the GCSE transmission is to be limited to only cells in eNB 1's coverage area.

Referring to step 3, based on the request from the GCSE AS, and based on the configuration of cells of the MBMS service area, the BM-SC can determine an indicator to be sent to eNB1 and eNB2. The indicator can indicate a list of cells to be included for group communication, or can include a list of cells to be excluded from group communication, or can include an indication to stop service-area-restriction/override. In the example shown in FIG. 3, the BM-SC can set the indicator to indicate a list of cells (i.e., the cells corresponding to eNB2) to be excluded from group communication.

Referring to step 4, the BM-SC distributes SYNC protocol-data unit (PDU) Type X data frames (which include the indicator) to all eNBs. Referring to step 5, upon the reception of SYNC PDU Type X data frames (which include a list of excluded cells), eNB2 knows that eNB2 should stop the MBSFN transmission for this session. The cells corresponding to eNB2 can then only transmit MCCH, while muting MTCH transmission. In certain embodiments, eNB2 may use some kind of local broadcast, e.g., a cell-specific downlink-shared-channel-based (DL-SCH-based) broadcasting mode.

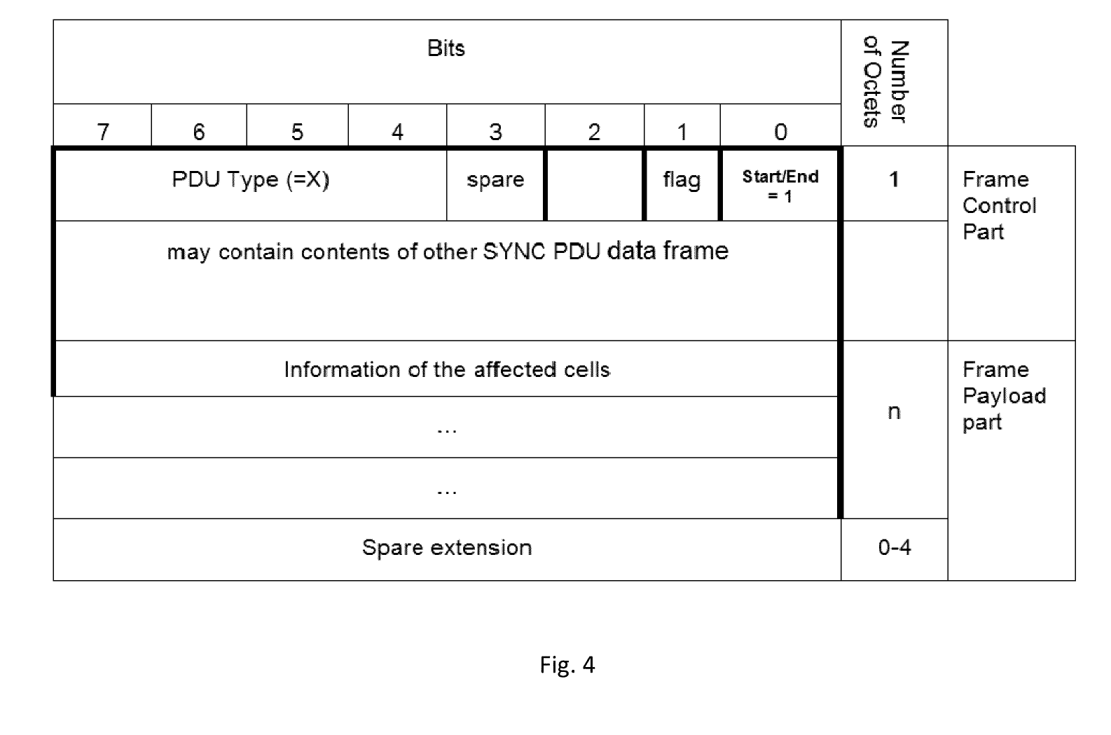

As described above, in certain embodiments of the present invention, a SYNC protocol is enhanced with a new SYNC PDU Type X data frame. One example of a proposed SYNC PDU Type X data frame is shown in FIG. 4. A SYNC PDU Type X data frame may also contain content of an existing SYNC PDU Type 0/1/2/3 data frame.

FIG. 4 illustrates an enhanced SYNC-PDU-Type-X data frame for starting GCSE area restriction/override in accordance with embodiments of the present invention. Referring to FIG. 4, when Start/End=1, the SYNC PDU Type X data frame notifies the eNB about the GCSE area restriction/override. The flag field indicates the usage of the cell list:
If “flag=1,” only those cells indicated in the SYNC PDU Type X data frame will participate in the MBSFN transmission. Other cells that are not listed, but that belong to the same MBSFN area, only transmit MCCH, and these other cells mute the related MTCH transmission. These other cells may use some kind of local broadcast. For example, these other cells may use a cell-specific downlink-shared-channel-based (DL-SCH-based) broadcasting mode.
If “flag=0,” the cells indicated in the SYNC PDU Type X data frame will generally not participate in the MBSFN transmission. These indicated cells only transmit MCCH, and these indicated cells mute the related MTCH transmission. The indicated cells may use some kind of local broadcast. For example, the indicated cells may use a specific DL-SCH-based broadcasting mode.
   The information of the cells could be the list of cell IDs or eNB IDs, or the list of TAI (Tracking Area Identities), or area names, or location codes, or any other information that can identify the affected cells.

A BM-SC may send multiple SYNC-PDU-T e-X data frames with different lists of cells in case many cells need to be notified.

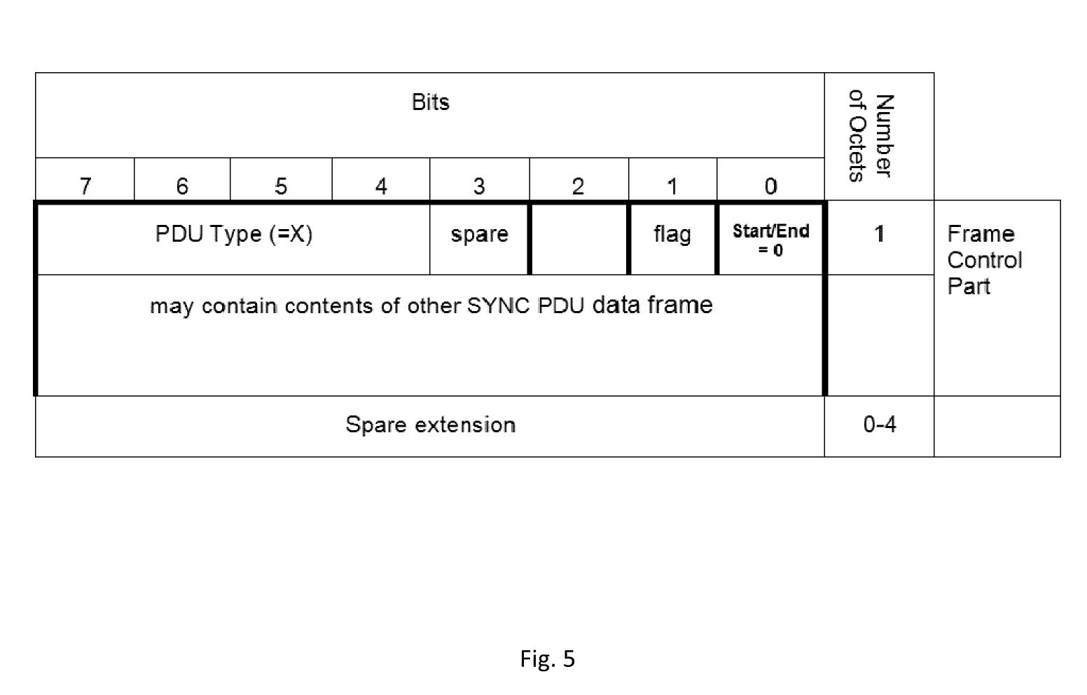

FIG. 5 illustrates an enhanced SYNC-PDU-T e-X data frame for stopping GCSE area-restriction/override. Referring to FIG. 5, when Start/End=0, the SYNC-PDU-T e-X data frame notifies the eNB that there is no area restriction/override. The eNB can then consider the MBMS session as a normal MBMS session, which all eNBs of the MBSFN area will participate in the MBSFN transmission.

A BM-SC may repeat the sending of a SYNC PDU Type X data frame in order to improve the reliability of the delivery to the eNBs. Using inband signalling can quickly change a group communication service area because the SYNC PDU data frame can be directly transmitted from the BM-SC to the eNB without traversing through a MME and without traversing through a multi-cell/multicast coordination entity (MCE).

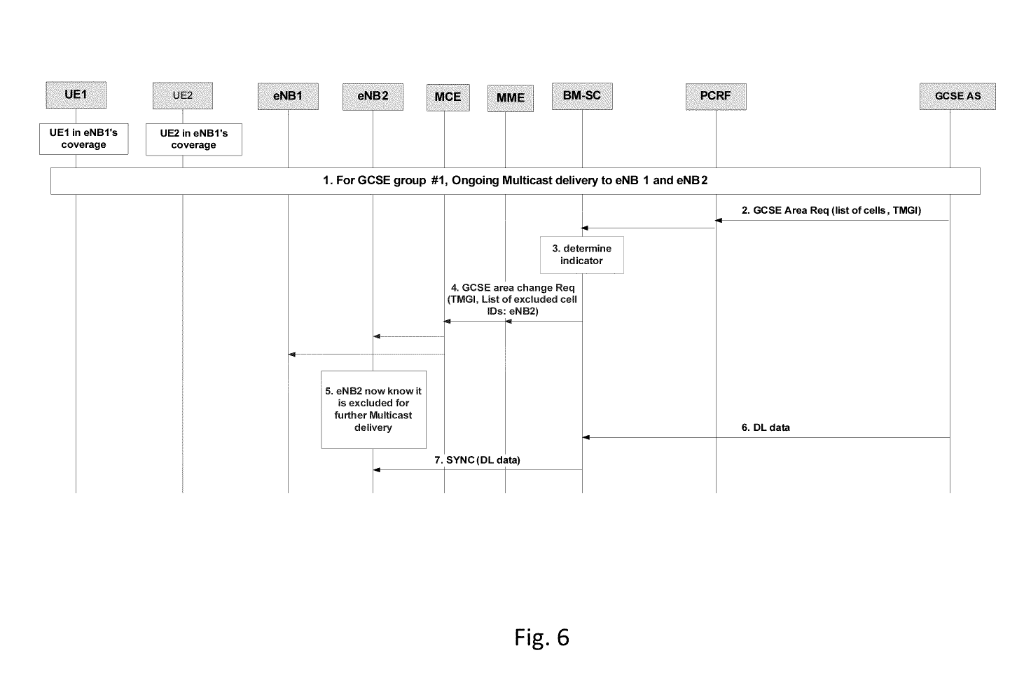

FIG. 6 illustrates enhancing session control in accordance with embodiments of the present invention. Referring to FIG. 6, a BM-SC can use session signalling to change the GCSE service area. In step 2, the GCSE AS sends a GCSE area request. In step 3, based on the request from the GCSE AS and the configuration of the cells of the MBMS service area, the BM-SC determines an indicator to be sent to eNBs. The indicator can indicate cells to be included for group communication, or indicate cells to be excluded from group communication, or indicate a stop to service area restriction/override. The indicator could be a list of cell IDs or eNB IDs, or cells identified by the list of TAI (Tracking Area Identities), or area names, or location codes, or any other information that can identify the affected cells. In the example of FIG. 6, the cells of eNB2 are to be excluded from group communication.

In step 4, the BM-SC initiates a change procedure. The change procedure may be an enhancement to a current MBMS Session Start or Update procedure or may be a new procedure dedicated for GCSE usage. The BM-SC can send a GCSE area change request message to a MBMS-GW, which is then sent to a radio-access-network (RAN) via a mobility management entity (MME). Alternatively, the multi-cell/multicast coordinating entity (MCE) may perform optimization to distribute the GCSE area change request message only to affected eNBs. The MCE can perform the optimization based on the information of the affected cells received via the GCSE area change request message, and the cell information provided by the eNB.

In step 5, upon the reception of the GCSE area change request message (including the list of excluded cells) by eNB2, eNB2 then knows to stop the MBSFN transmission for the session. The cells corresponding to eNB2 only transmit MCCH and mute the related MTCH transmission. eNB2 may use some kind of local broadcast. For example, eNB2 can use a cell-specific DL-SCH-based broadcasting mode.

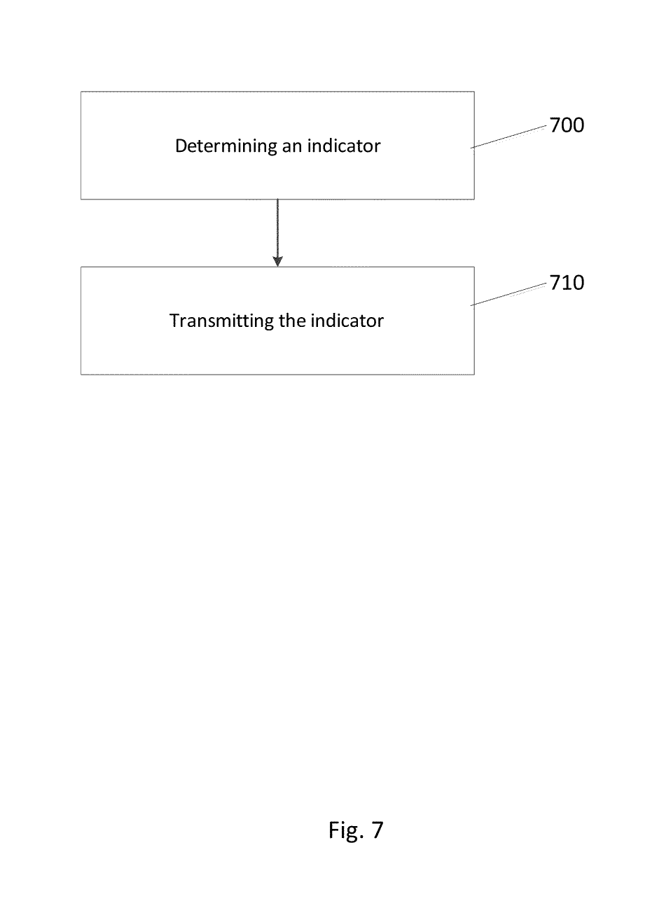

FIG. 7 illustrates a flowchart of a method in accordance with an embodiment of the invention. The method illustrated in FIG. 7 includes, at 700, determining, by a broadcast/multicast service center, an indicator based on a received request. The method can also include, at 710, transmitting the indicator towards a base station. The indicator affects the coverage of a multicast-broadcast single-frequency network transmission.

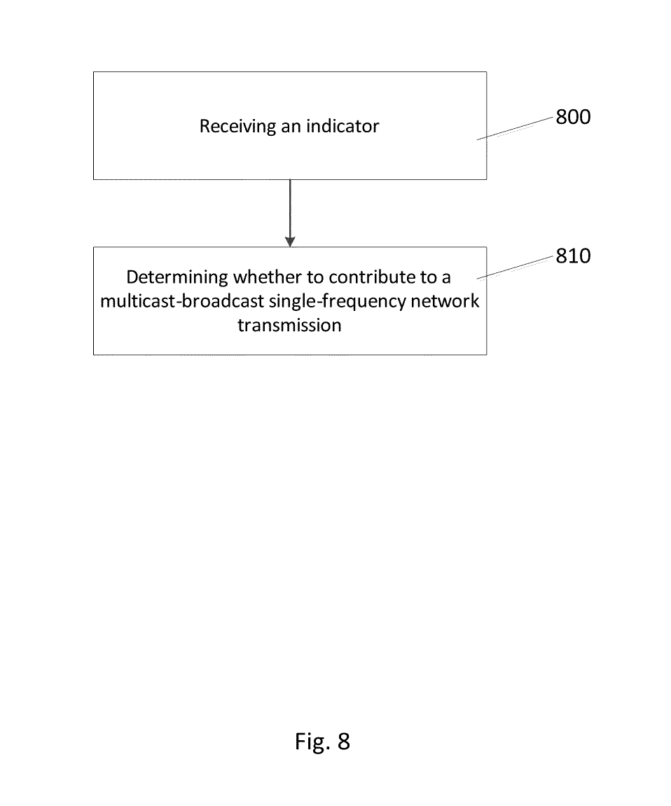

FIG. 8 illustrates a flowchart of a method in accordance with an embodiment of the invention. The method illustrated in FIG. 8 includes, at 800, receiving, by a base station, an indicator. The method also includes, at 810, determining, based on the indicator, whether to contribute to a multicast-broadcast single-frequency network transmission. The indicator indicates at least one of cells to be included for the multicast-broadcast single-frequency network transmission, cells to be excluded from the multicast-broadcast single-frequency network transmission, and a stop to service area restriction/override.

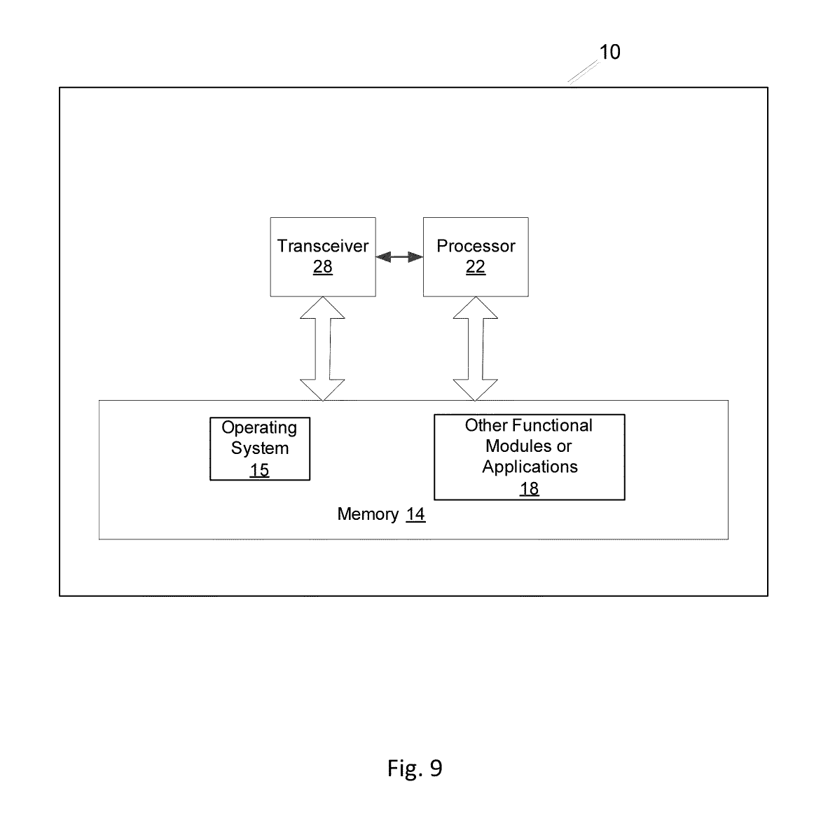

FIG. 9 illustrates an apparatus in accordance with embodiments of the invention. In one embodiment, the apparatus can be a base station/eNB. In one embodiment, the apparatus can be an MCE. In another embodiment, the apparatus can be a UE. In another embodiment, the apparatus can be an MBMS GW. In another embodiment, the apparatus can be a BM-SC. In another embodiment, the apparatus can be a GCSE AS. In another embodiment, the apparatus can be an MME. Apparatus 10 can include a processor 22 for processing information and executing instructions or operations. Processor 22 can be any type of general or specific purpose processor. While a single processor 22 is shown in FIG. 9, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 includes any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software.

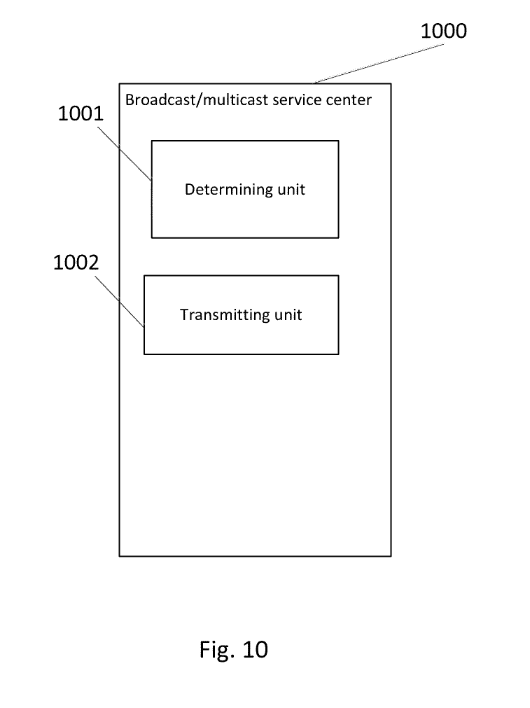

FIG. 10 illustrates an apparatus in accordance with another embodiment. Apparatus 1000 can be a broadcast/multicast service center, for example. Apparatus 1000 can include a determining unit 1001 that determines an indicator based on a received request. Apparatus 1000 can also include a transmitting unit 1002 that transmits the indicator towards a base station. The indicator affects the coverage of a multicast-broadcast single-frequency network transmission.

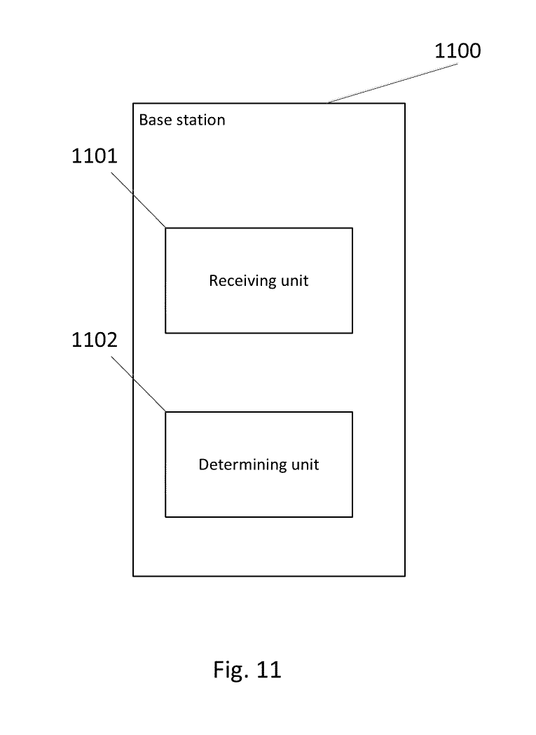

FIG. 11 illustrates an apparatus in accordance with another embodiment. Apparatus 1100 can be a base station, for example. Apparatus 1100 can include a receiving unit 1101 that receives an indicator. Apparatus 1100 can also include a determining unit 1102 that determines, based on the indicator, whether to contribute to a multicast-broadcast single-frequency network transmission. The indicator indicates at least one of cells to be included for the multicast-broadcast single-frequency network transmission, cells to be excluded from the multicast-broadcast single-frequency network transmission, and a stop to service area restriction/override.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

We claim:

1. A method, comprising:
determining, by a broadcast/multicast service center, an indicator based on a received request;
transmitting the indicator towards a base station, wherein the indicator affects the coverage of a multicast-broadcast single-frequency network transmission.

2. The method according to claim 1, wherein the determining comprises determining the indicator based on a configuration of cells that are using multimedia-broadcast-multicast service.

3. The method according to claim 1, wherein the transmitting comprises transmitting the indicator towards the base station via in-band signalling.

4. The method according to claim 3, wherein the in-band signalling is performed using a certain synchronization protocol-data-unit type.

5. The method according to claim 1, wherein the transmitting comprises transmitting the indicator towards the base station via session control signalling.

6. The method according to claim 1, wherein the indicator identifies at least one of cells to be included for multicast-broadcast single-frequency network transmission, cells to be excluded from multicast-broadcast single-frequency network transmission, and a stop to service area restriction/override.

7. The method according to claim 1, wherein the transmitting is optimized to only transmit the indicator to affected base stations.

8. An apparatus, comprising:
at least one processor; and
at least one memory including computer program code,
the at least one memory and the computer program code configured, with the at least one processor, to cause the apparatus at least to determine an indicator based on a received request; transmit the indicator towards a base station, wherein the indicator affects the coverage of a multi-broadcast single-frequency network transmission.

9. The apparatus according to claim 8, wherein the determining comprises determining the indicator based on a configuration of cells that are using multimedia-broadcast-multicast service.

10. The apparatus according to claim 8, wherein the transmitting comprises transmitting the indicator towards the base station via in-band signalling.

11. The apparatus according to claim 10, wherein the in-band signalling is performed using a certain synchronization protocol-data-unit type.

12. The apparatus according to claim 8, wherein the transmitting comprises transmitting the indicator towards the base station via session control signalling.

13. The apparatus according to claim 8, wherein the indicator identifies at least one of cells to be included for multicast-broadcast single-frequency network transmission, cells to be excluded from multicast-broadcast single-frequency network transmission, and a stop to service area restriction/override.

14. The apparatus according to claim 8, wherein the transmitting is optimized to only transmit the indicator to affected base stations.

15. A computer program product embodied on a non-transitory computer readable medium, the computer program product configured to control a processor to perform the method according to claim 1.

16. A method, comprising:
receiving, by a base station, an indicator; and
determining, based on the indicator, whether to contribute to a multicast-broadcast single-frequency network transmission, wherein the indicator indicates at least one of cells to be included for the multicast-broadcast single-frequency network transmission, cells to be excluded from the multicast-broadcast single-frequency network transmission, and a stop to service area restriction/override.

17. The method according to claim 16, wherein the receiving comprises receiving the indicator from a broadcast/multicast service center via in-band signalling.

18. The method according to claim 17, wherein the in-band signalling is performed using a certain synchronization protocol-data-unit type.

19. The method according to claim 16, wherein the receiving comprises receiving the indicator from a broadcast/multicast service center via session control signalling.

20. An apparatus, comprising:
at least one processor; and
at least one memory including computer program code,
the at least one memory and the computer program code configured, with the at least one processor, to cause the apparatus at least to
receive an indicator; and
determine, based on the indicator, whether to contribute to a multicast-broadcast single-frequency network transmission, wherein the indicator indicates at least one of cells to be included for the multicast-broadcast single-frequency network transmission, cells to be excluded from the multicast-broadcast single-frequency network transmission, and a stop to service area restriction/override.

21. The apparatus according to claim 20, wherein the receiving comprises receiving the indicator from a broadcast/multicast service center via in-band signalling.

22. The apparatus according to claim 21, wherein the in-band signalling is performed using a certain synchronization protocol-data-unit type.

23. The apparatus according to claim 20, wherein the receiving comprises receiving the indicator from a broadcast/multicast service center via session control signalling.

24. A computer program product embodied on a non-transitory computer readable medium, the computer program product configured to control a processor to perform the method according to claim 16.
